(19) United States
(12) Patent Application Publication
(10) Pub. No.: US 2016/0098434 A1
(43) Pub. Date: Apr. 7, 2016

(54) HARDWARE ACCELERATOR FOR HANDLING RED-BLACK TREES

(71) Applicant: COMMISSARIAT A L'ENERGIE ATOMIQUE ET AUX ENERGIES ALTERNATIVES, Paris (FR)

(72) Inventors: Alexandre CARBON, BURES-SUR-YVETTE (FR); Yves LHUILLIER, PALAISEAU (FR); Henri-Pierre CHARLES, GRENOBLE (FR)

(21) Appl. No.: 14/893,034

(22) PCT Filed: May 22, 2014
(86) PCT No.: PCT/EP2014/060544

§ 371 Date: Nov. 20, 2015

(30) Foreign Application Priority Data
Jun. 5, 2013 (FR) 1355181

(51) Int. Cl. G06F 17/30; G06F 12/08; G06F 12/10

(52) U.S. Cl. CPC G06F 17/30327; G06F 17/30504; G06F 12/1036; G06F 12/0831

(57) ABSTRACT

A hardware accelerator for handling red-black trees, each node of a tree including a binary color indicator, a key and the addresses of a parent node and two children nodes, the accelerator including at least two registers termed node registers, capable of storing the set of data fields of two nodes of a tree; and logic units configured for receiving from a processor at least one input data item selected from an address of a tree node and a reference key, as well as at least one instruction to be executed; for executing the instruction by combining elementary instructions on the data stored in the node registers and for supplying to the processor at least one output data item including an address of a node. A processor and computer system including such a hardware accelerator is provided.

The invention relates to a hardware accelerator—i.e. a dedicated digital circuit cooperating with a processor or incorporated in the latter for accelerating certain data processing operations—for handling data structures known as ‘red-black trees’. The invention also relates to a processor incorporating such a hardware accelerator and to a computer system including a processor, such a hardware accelerator and a memory.

Red-black trees, or colored trees, are well-known data structures for storing data sorted according to a reference key. These data structures are binary trees to which is added a coloring property of the nodes in which the handled data is contained. This property enables these trees to be handled with a complexity less than that of conventional binary trees, in O(log n), where n is the total number of nodes in the tree, both for insertion and for deletion operations. This representation is notably heavily used as part of implementing associative arrays. Associative arrays, implemented in the form of red-black trees consist of a collection of pairs of keys and values for associating a set of keys with a corresponding set of values. There are many programming libraries optimized for handling red-black trees, e.g. as part of the GNU C++ standard library.

Nevertheless, it has been demonstrated that the optimum implementation of associative arrays, at least for creating memory allocators, is not based on the use of red-black trees, but hash tables. See in this regard Emery D. Berger, Benjamin G. Zorn and Kathryn S. McKinley. ‘Reconsidering custom memory allocation’, Proceedings of the 17th ACM SIGPLAN conference on Object-oriented programming, systems, languages, and applications (OOPSLA '02). ACM, New York, N.Y., USA, 1-12, 2012.

The article by Amir Roth, Andreas Moshovos and Gurindar S. Sohi ‘Dependence based prefetching for linked data structures’ SIGOPS Oper. Syst. Rev. 32, 5 (October 1998), 115-126, describes a unit for prefetching linked data structures with pointers. Such a unit can be used to accelerate the path of the pointer chains, and therefore the processing of red-black trees which, like many other data structures, use such chains. Such a unit is not, however, specific to the handling of red-black trees, and only allows obtaining a limited gain in execution time.

The invention aims to accelerate the handling of red-black trees, and accordingly the associative arrays implemented by means of such trees.

In accordance with the invention, such an aim is achieved thanks to a hardware accelerator, used in conjunction with a slightly modified software representation of the red-black trees.

One object of the invention is therefore a hardware accelerator for handling red-black trees, each ‘tree’ including multiple nodes, each ‘node’ including data fields of predefined length representing:

a color indicator, taking a binary value;

a key;

an address of another node in the same tree, termed a ‘parent’;

an address of another node in the same tree, termed a ‘left child’; an

an address of another node in the same tree, termed a ‘right child’;

said hardware accelerator including:

at least two registers termed ‘node registers’, capable of storing the set of fields of two nodes of a ‘tree’; and

logic units configured for receiving from a processor at least one input data item selected from an address of a ‘tree’ node and a ‘reference key’, as well as at least one instruction to be executed; for executing said instruction by performing a combination of the following operations:
sending an address to said memory, receiving from said memory the set of data fields of the node of said tree corresponding to said address and writing them in a ‘register’ replacing the data fields;
sending to the memory the set of data fields of a node of said tree as well as an address of said memory in which said data fields must be recorded;
changing the value of a color indicator stored in a ‘node register’; and
exchanging therebetween two addresses stored in two ‘node registers’;
and for supplying said processor with at least one output data item including an address stored in a ‘node register’.

According to different advantageous features of the invention, taken separately or in combination:

The hardware accelerator may also include a register, termed a ‘reference register’, capable of storing either a ‘reference key’, received from said processor, or a ‘reference key’ and a color indicator.

Said logic units may include a processing unit and a control unit, said control unit being configured for: receiving a ‘node address’ of a ‘tree’ as input data and transmitting it to said memory; receiving a ‘reference key’ as input data and storing it in said reference register; receiving an ‘instruction to be executed’ as input data, and one or more condition signals from said processing unit; in response to said instruction to be executed and to said condition signal or signals, generating signals for controlling said processing unit; and supplying, as output data, a node address received from said processing unit.

Said control unit may be a finite state controller.

The hardware accelerator may also include a register, termed a ‘temporary register’, capable of storing an address, termed a ‘temporary address’, of a ‘tree’ node.

Said processing unit may be configured for executing, in response to a ‘control signal’, at least the following operations:
a. comparing the reference key stored in said reference register with a key stored in a data field of a ‘node register’, and supplying the result of this comparison to said control unit as a condition signal;
b. comparing with a predetermined value an address stored in a data field of a ‘node register’, and supplying the result of this comparison to said control unit as a condition signal;
c. comparing with a predetermined value a color indicator stored in a data field of a ‘node register’, and supplying the result of this comparison to said control unit as a condition signal;
d. changing the value of a color indicator stored in a data field of a ‘node register’;
e. sending to said memory, for writing, the set of data fields of a ‘node register’;
f. receiving from said memory the set of data fields of a ‘tree’ node and storing them in a ‘node register’;
g. writing said temporary address, stored in said temporary register, in a data field of a ‘node register’, replacing an address stored in said field; and
h. writing an address stored a data field of a node register in said temporary register, replacing said temporary address.

Said processing unit may include: a subtraction and selection unit configured for receiving at a first input, via a first multiplexer, the contents of said temporary register or of said reference register, at a second input, via a second multiplexer, a key or key and color indicator data field from a node register and at a control input, a control signal from said control unit, and for supplying at its output, according to said control signal, either one of said first and second inputs, or their difference; a reorganization unit configured for receiving a first input, the output of said comparison and subtraction unit, at a second input, a key or key and color indicator data field from a node register, at a third, a fourth and a fifth input, via said second multiplexer, three address data fields from a node register and at a control input, a control signal from said control unit; and for supplying: at a first output, a key, key and color indicator or address data field present at one of its inputs, the value of said color indicator capable of being modified, at a second output, an address data field present at its second, its third or its fourth address; and/or at a third output, the set of data fields representative of a node of said tree, obtained by selection and permutation of the data fields present at its inputs, with optional modification of a color indicator; a set of comparators to zero of the data fields supplied to the third, fourth and fifth input of said reorganization unit and of a color indicator stored in said reference register, the outputs of said comparators being supplied to said control unit as condition data; and a data distribution network configured for: supplying a data field from the first output of the reorganization unit either to said temporary register, or to said reference register, according to a control signal from said control unit, as well as to said control unit, supplying a data field from the second output of the reorganization unit to said memory; supplying data fields from the third output of the reorganization unit to said memory; supplying data fields from the third output of the reorganization unit or from said memory to one of said node registers, according to a control signal from said control unit.

Said processing unit may be configured for generating, in response to an instruction received as input data, a sequence of control signals for executing an operation selected from among the following:
A. Searching, in a red-black tree stored in said memory, for the successor node having a value key immediately greater than that of a node the address whereof is supplied as input data, and supplying, as output data, the address of said successor node;
B. Searching, in a red-black tree stored in said memory, for the predecessor node having a key with a value immediately less than that of a node the address whereof is supplied as input data, and supplying, as output data, the address of said successor node;
C. Searching, in a red-black tree stored in said memory and of which the address of an access point is supplied as first input data, for the node the address whereof is supplied as second input data, deleting it and modifying the structure of the red-black tree accordingly;
D. Inserting, in a red-black tree stored in said memory and of which the address of an access point is supplied as first input data, a node the address whereof is supplied as second input data and modifying the structure of the red-black tree accordingly;
E. Searching, in a red-black tree stored in said memory and of which the address of an access point is supplied as first input data, for the first node whereof the key is greater than or equal to a reference key supplied as second input data and supplying, as output data, the address of this node; and
F. Searching, in a red-black tree stored in said memory and of which the address of an access point is supplied as first input data, for the first node the key whereof is strictly greater than or equal to a reference key supplied as second input data and supplying, as output data, the address of this node.

Said logic units may also include an interface device with said memory configured for: receiving from said control unit the address of a location of said memory; and transferring the contents of said memory location into a node register, or vice versa.

Such an accelerator may include exactly three node registers.

The color indicator and the key of each node may be represented by different bits of the same data field, said color indicator being represented by a single bit of said field.

More particularly, each node may be represented by: a data field whereof one bit represents said color indicator and the remaining bits represent said key; and three other data fields representing the addresses of said parent, left child and right child nodes; said data fields all having the same number of bits.

Another object of the invention is a processor including such a hardware accelerator as a functional unit having access to the first level of cache memory.

Yet another object of the invention is a computer system including a processor, a memory and such a hardware accelerator interconnected by a system bus, said processor being configured or programmed for communicating with said hardware accelerator via system requests and for ensuring cache consistency.

Other features, details and advantages of the invention will emerge from reading the description made with reference to the accompanying drawings given by way of example and which represent, respectively:

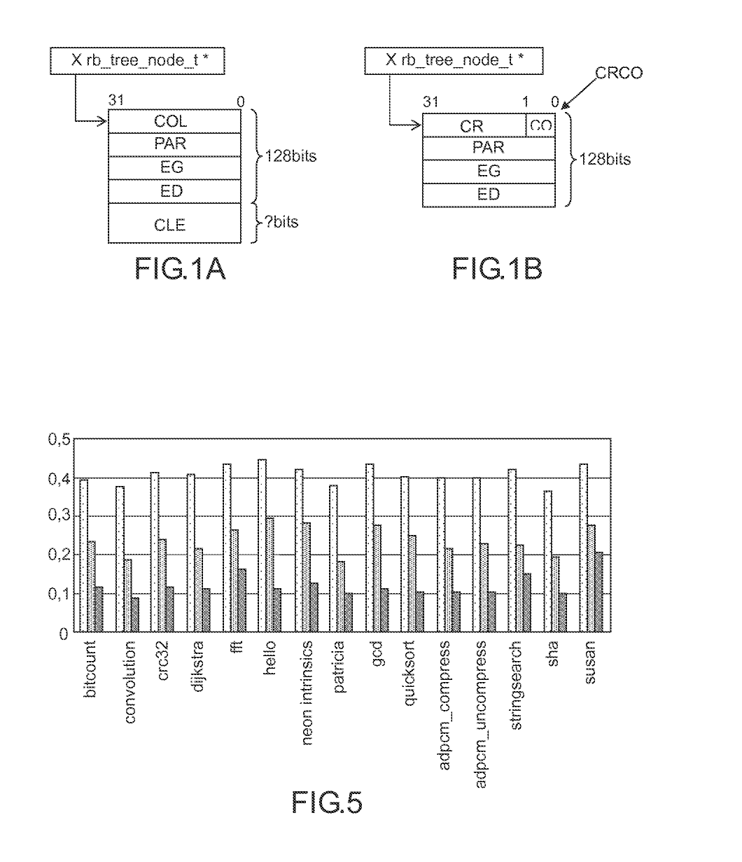

FIGS. 1A and 1B, respectively, a data structure used for representing a node of a red-black tree according to the prior art and according to the invention;

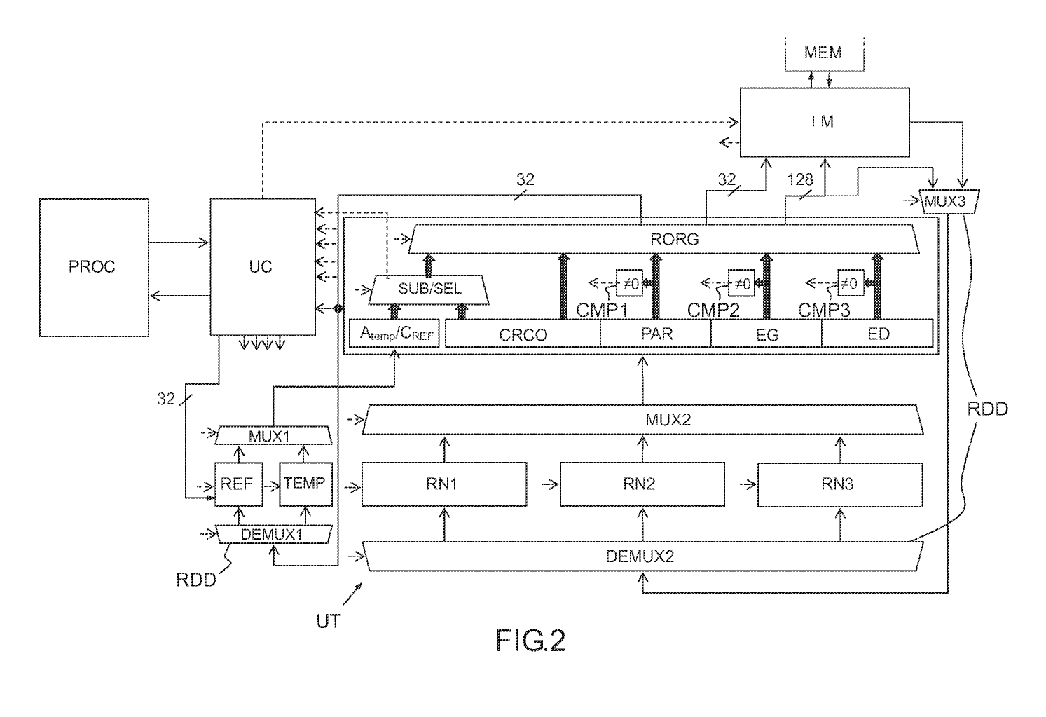

FIG. 2, the architecture of a hardware accelerator according to one embodiment of the invention;

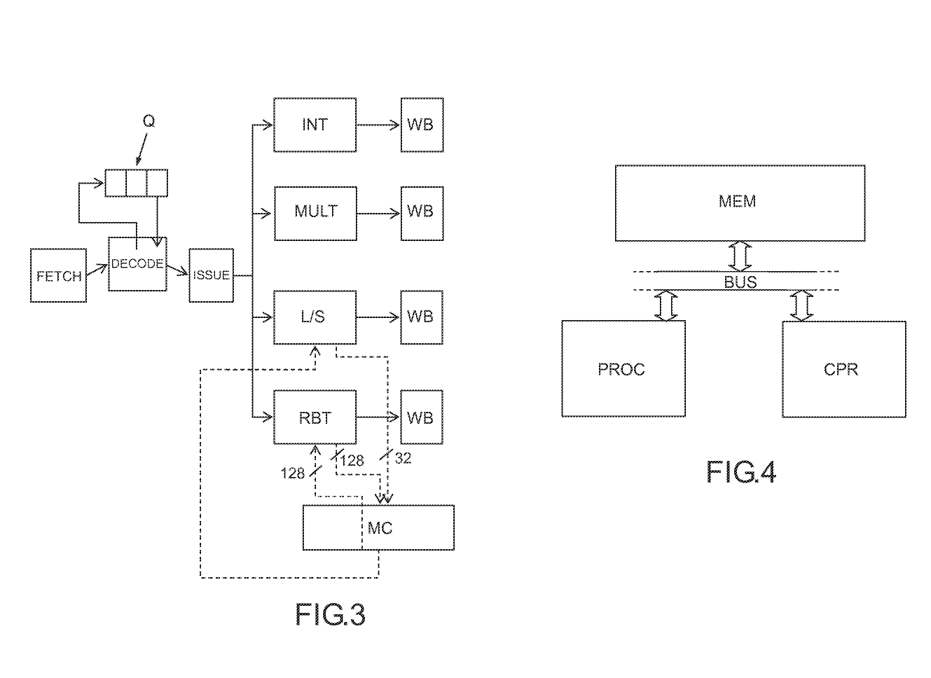

FIG. 3, a processor incorporating a hardware accelerator according to one embodiment of the invention;

FIG. 4, a computer system including a processor, a hardware accelerator according to another embodiment of the invention and a memory; and

FIG. 5, a graph illustrating the performance gain obtained thanks to a hardware accelerator according to one embodiment of the invention compared to standard purely software processing of red-black trees and compared to optimized software processing implemented in the LLVM environment.

A red-black tree is a binary tree in which each node has a property called color, which may take two values - conventionally ‘red’ and ‘black’. As in any binary tree, each node has a ‘parent’ node (except the root node) and two ‘children’ nodes (except the ‘leaf’ nodes, which end the branches of the tree), and more precisely a ‘left’ child and a ‘right’ child. Each node of a red-black tree (but this is also true for a ‘generic’ binary tree) is also characterized by a ‘key’. The keys of the various nodes are ordered, and the following rule applies: the left child node of each node has a key with a value less than that of its parent's key, the right child node of each node has a key with a value greater than that of its parent's key. A red-black tree must further satisfy the following properties:

the root node is black;

the leaf nodes are black;

the children of each red node are black;

each simple path from a node to any of its descendants contains the same number of black nodes.

These properties ensure that the tree is at least approximately balanced, which is not the case of a generic binary tree.

A red-black tree is, in the context of a preferred embodiment of the invention as in the context of other software implementations such as that of the GNU C++ standard library, referenced from a node, termed a ‘header node’ or more simply a ‘header’. This header node has the same structure as the nodes of the tree, but its parent node is the root node of the tree, its left child node is the farthest left leaf node on the tree, i.e. the node with the smallest key of all the nodes on the tree, its right child node is the farthest right leaf node on the tree, i.e. the node with the largest key of all the nodes on the tree. Finally, the color field and that of the header node key are unused. The header node is a point of entry in the tree used for quickly accessing the node in the red-black tree, when handling the latter. Another advantage of using a header node is linked to the stability of this node throughout the life of the tree, while the root node may change during handling of the tree.

Conventionally, a binary tree node is represented by a data structure of the type illustrated in FIG. 1A. This structure includes:

a color field COL, e.g. of the ‘long’ type, encoded in 32 bits;

three fields containing addresses of other nodes in the tree (PAR, EG, ED), respectively the parent node, the left child node and the right child node), e.g. each encoded in 32 bits; and

a field CLE containing the node key, encoded in a variable number of bits.

It follows that the overall size of the data structure representing a node of a red-black tree is variable.

But to produce a hardware accelerator it is necessary that each node has a constant, predefined size. Consequently, the key CLE is replaced by a ‘reduced key’ consisting of a predetermined number of bits. The replacement of a key of variable size by a key of fixed size may result in the transition from a total order of nodes to a partial order in which two nodes having different keys have the same reduced key. It is still possible to ensure that the transition from the key to the reduced key preserves the order of the nodes, at least in the sense of a partial order; and if the key of node n is greater than the key of node m, then the reduced key of node n is greater than or equal to that of node m. In the case of equality, post-processing software may be used to resolve any ambiguity in sequencing by returning (outside of the hardware accelerator) to a complete representation of the key.

Given that color takes a binary value, the encoding in 32 bits of the conventional implementation is highly redundant; this is without serious consequence in the case of purely software processing, but unnecessarily increases the cost and complexity of a hardware accelerator. Consequently, in a data structure optimized for implementing the invention color is coded in a single bit.

Finally, for producing a hardware accelerator it is preferable that all the data fields representing a node have the same size, e.g. 32 bits.

Thus the data structure in FIG. 1B is arrived at, including 4 fields of 32 bits:

one field CRCO, containing a reduced key subfield CR (in what follows simply referred to as a ‘key’), of 31 bits, and a color subfield CO, of only 1 bit;

three address fields of 32 bits each, as in the conventional structure;

for a total of 128 bits per node. Of course, the number of bits of each data field may be chosen as other than 32.

The representation of a red-black tree by the data structure in FIG. 1B (or an equivalent structure, obtained by modifying the order of the various fields) is not essential, but is preferred.

The variable X, of type ‘rb_tree_node_t*’ (pointer to a red-black tree node) contains the address of the first data field of such a node (here, the field CRCO, but this is not essential).

A hardware accelerator according to the invention executes, on behalf of a processor, some instructions needed for handling red-black trees, and notably:

A. Searching, in a red-black tree stored in memory, for the ‘successor’ node of a given node, i.e. the node having a key of immediately greater value. The parameter of the function (data supplied as input to the hardware accelerator) is the address of the node whose successor must be found; the output value of the function and the address of said successor node.

B. Searching, in a red-black tree stored in memory, for the ‘predecessor’ node of a given node, i.e. the node having a key of immediately less value. The parameter of the function is the address of the node whose successor must be found; the output value of the function and the address of said predecessor node.

C. Searching, in a red-black tree stored in memory, for a node whose address is supplied as input, deleting it and modifying the structure of the red-black tree accordingly, so as to comply with the rules set out above. The parameters of the function are the address of an access point to the tree and that of the node to be deleted; the optional output value, is the address of the deleted tree node, corresponding to the second parameter of the function.

D. Inserting, in a red-black tree stored in memory, a node whose address is supplied as input, and modifying the structure of the red-black tree accordingly, so as to comply with the rules set out above. The parameters of the function are the address of the tree header and that of the node to be added.

E. Searching, in a red-black tree stored in said memory and whose address is supplied as first input data, for the first node whose key is greater than or equal to a reference key supplied as second input data and supplying, as output data, the address of this node. The parameters of the function are the address of an access point to the tree and the reference key; the output value is the address of the found node.

F. Searching, in a red-black tree stored in said memory and whose address is supplied as first input data, for the first node whose key is strictly greater than or equal to a reference key supplied as second input data and supplying, as output data, the address of this node. The parameters of the function are the address of an access point to the tree and the reference key; the output value is the address of the found node.

The access point to the tree is generally its header node.

The accelerator may optionally also execute other instructions. It is also possible to envisage other equivalent instruction sets, enabling them also to handle red-black trees.

In any case, the accelerator must have access to a memory, shared with the processor, storing the data structures to be handled. This memory must be the level 1 cache of the processor, or a memory kept consistent with said cache by known mechanisms of the prior art.

The accelerator receives the instructions and their parameters from the processor, and returns the output value thereto.

To be able to execute these instructions, an accelerator according to one embodiment of the invention includes at least two (preferably three) registers capable of storing the set of data fields of a node, and logic circuits for executing simpler operations, into which the above instructions may be split. These operations are as follows:

sending an address field to said memory, receiving from said memory the set of data fields of the node of said tree corresponding to said address and writing them in a register replacing the data fields stored in said register;

sending to the memory the set of data fields of a node of said tree as well as an address of said memory in which said data fields must be recorded;

changing the value of a color indicator stored in a node register; and

exchanging therebetween two addresses stored in two node registers.

The output value, supplied to the processor, is an address field.

In a preferred embodiment of the accelerator of the invention, these operations are split into even simpler, ‘elementary’ operations. FIG. 2 schematically illustrates the architecture of such an accelerator, which includes:

a control unit UC, modeled by a finite state controller.

a processing unit UT, including in its turn a subtraction and selection unit SUB/SEL, a reorganization unit RORG, multiplexers MUX1 and MUX2 located at the inputs of these units, comparators to zero (or, equivalently, comparators to one) CMP1, CMP2, CMP3 and a data distribution network RDD including in its turn, a multiplexer MUX3 and demultiplexers DEMUX1, DEMUX2;

a memory interface IM; and

three node registers RN1, RN2, RN3 (as mentioned earlier, two of these registers could suffice, three is the optimum number while a higher number does not bring any particular advantage), of 128 bits in the case of the representation in FIG. 1B, and two additional registers that are capable of storing a single data field (32 bits, in the case of the representation in FIG. 1B): a ‘temporary’ register TEMP for storing an address field and a ‘reference’ register REF for storing a key/color field.

The control unit may be modeled by a finite state controller. It performs the following operations:

Receiving from a processor PROC (where appropriate via an interface circuit, not represented) an instruction to be executed—e.g. one of the instructions A to F functionally described above—as well as its arguments—typically, one or two respective node addresses of a red-black tree stored in a memory MEM, and where appropriate a reference key value. The address type parameters are communicated to the memory interface IM which retrieves the corresponding data and writes it in one or more node registers via the data distribution network. An optional reference key type parameter is recorded in said reference register REF. The instruction determines the control sequence executed by the control unit.

Receiving condition signals from the processing unit—and more precisely from the comparators CMP1-CMP3 and from the subtraction and selection unit SUB/SEL. The paths of these signals are not represented in their entirety so as not to overload the figure; only represented are arrows leaving the units generating these signals and arrows entering the control unit.

According to the selected control sequence (and therefore the instruction being executed), an internal state and the condition signals received, sending control signals to the various components of the processing unit (as for the condition signals, the paths of these signals are not represented in their entirety).

Receiving from the processing unit (or taking from a register) the address of a node and transmitting it to the processor as a result of the instruction.

With regard to the processing unit UT:

The first multiplexer MUX1 selects, according to a control signal, either the contents A_{TEMP} of the temporary registry TEMP, or those (C_{REF}) of the reference register REF. The selected data (32 bits) is transmitted to a first input of the subtraction and selection unit SUB/SEL.

The second multiplexer MUX2 selects, according to a control signal, the contents of one of the node registers RN1, RN2, RN3. The various (128) bit data fields thus selected are processed differently:
the field CRCO (reduced key and color) is supplied to a second input of the subtraction and selection unit SUB/SEL and also supplied as input to the reorganization unit;
the other fields (PAR, address of the parent node; EG, address of the left child; ED, address of the right child) are compared to zero (or, equivalently, to one) by the comparators CMP1, CMP2, CMP3 for generating respective condition signals, and also supplied as input to the reorganization unit RORG.

As its name indicates, the subtraction and selection unit SUB/SEL may, according to a control signal, compare its inputs (subtraction) or select one of them. Its output is supplied as input to the reorganization unit RORG.

The reorganization unit RORG has three outputs (which are not necessarily active at the same time):
a first 32-bit output, on which one of the data fields is found present at its inputs; if this field is a key and color field, the bit indicative of the color may be changed; the selection of the input which is found at the first output and the optional changing of the color bit depend on a control signal;
a second 32-bit output, on which one of the address fields is found present at its inputs and originating from a node register via the second multiplexer; the selection of the address field which is found at the first output depends on a control signal;
a third 128-bit output, on which a reconstituted node structure is found by selecting and permuting four of the data fields present at the inputs of the unit; the selection and permutation performed depend on a control signal. In concrete terms, said third output includes a key and color field originating from the first or the second input, with optional modification of the color indicator bit, and three address fields originating from the third, fourth and fifth input (the order of which may be modified).

These outputs are supported by the data distribution network RDD. More precisely:

the first demultiplexer DEMUX1 is used to supply the data at the first output of the reorganization unit to the input of the temporary register or of the reference register;

the data at the second output of the reorganization unit (necessarily an address) is supplied to the memory interface IM;

the data at the third output of the reorganization unit is also supplied to the memory interface IM to be recorded in the memory MEM, at the address specified by the data at the second output; it is also supplied as input to the third multiplexer MUX3.

This third multiplexer MUX3 also receives, at another input, a node data structure (128 bits) originating from the memory MEM—the contents of the memory cell the address whereof has been supplied either by the control unit, or by the aforementioned second output of the reorganization unit. The multiplexer selects one of its inputs, and sends it to the second multiplexer DEMUX2, which transfers it to one of the node registers RN1, RN2, RN3.

All these multiplexers and demultiplexers are controlled by respective control signals.

In addition, still via the data distribution network:

the data at the first address of the reorganization unit (an address) may be supplied to the control unit, which in its turn transmits it to the processor PROC as output data; and

a reference key received as an instruction parameter may be transmitted from the control unit to the reference register REF to be recorded therein.

The processing unit UT may therefore implement, under the control of the control unit UC, the following ‘elementary’ operations:

a. comparing a reference key stored in the reference register REF with a key stored in a data field of a node register, and supplying the result of this comparison to the control unit as a condition signal;

b. comparing to zero (or to another predetermined value) an address stored in a data field of a node register, and supplying the result of this comparison to the control unit as a condition signal;

c. comparing to zero (or to one) a color indicator stored in a data field of a node register, and supplying the result of this comparison to the control unit as a condition signal;

d. changing the value of a color indicator stored in a data field of a node register;

e. sending to the memory MEM, for writing, via the interface IM, the set of data fields of a node register;

f. receiving from said memory the set of data fields of a tree node and storing them in a node register;

g. writing the temporary address, stored in the temporary register TEMP, in a data field of a node register, replacing an address stored in said field; and

h. writing an address stored a data field of a node register in said temporary register, replacing said temporary address.

Each of these elementary operations is performed in two steps, each corresponding to a clock cycle. The first step includes selecting the inputs of the reorganization unit and of the subtraction and selection unit by the multiplexers MUX1 and MUX2, and loading new data in the registers, the second step corresponds to the processing performed by the reorganization unit and the subtraction and selection unit.

The architecture of FIG. 2 is optimized in such a way as to reduce the cost, complexity, and consumption of the accelerator by reusing the same components for performing multiple operations when this is possible. One consequence of this optimization is that useless operations are possible in principle (e.g. a comparison between key/color data and an address in the unit SUB/SEL). This does not matter since the control sequences of the control unit make the execution of these operations impossible.

Splitting the instructions A-F defined above (or instructions of an equivalent set) into elementary operations that can be performed by the processing unit poses no particular difficulty. It will be noted that an operation as significant as the exchange of two addresses stored in two node registers is not elementary, but is performed in three phases using the temporary register for intermediate storage.

It is also possible, without departing from the scope of the invention, to design a processing unit implementing a different set of elementary instructions. In any case, the transition from a functional definition of the unit to a concrete embodiment by electronic components does not pose any fundamental difficulty.

A hardware accelerator according to one embodiment may be incorporated in the ‘pipeline’ of a processor in such a way as to constitute a functional unit thereof. In this case, the hardware accelerator benefits from direct access to the level 1 cache memory and its use brings into play specific instructions of the processor. FIG. 3 illustrates schematically the structure and operation of such a processor. The pipeline includes a unit ‘FETCH’ responsible for loading an instruction from the memory, a unit ‘DECODE’ for decoding the instruction and storing the decoded instruction in a queue Q, a unit ISSUE which selects a ready instruction (whereof all the inputs are available) from the instructions in the queue Q and transmits this instruction to a functional unit selected from among: a unit INT (responsible for integer operations), a unit MULT (responsible for multiplication operations), a unit L/S (‘Load/Store’: responsible for reads/writes from/to the memory) and the hardware accelerator RBT, these last two units having direct access to the level 1 cache memory, MC. Each unit transmits the result of the processing that it executes to the unit WB. The unit WB (‘write-back’) is then responsible for updating the processor's registers. This embodiment is preferred since it benefits fully from the accelerated handling of the red-black trees. However, it is awkward to implement, since it requires a modification of the processor and its instruction set.

FIG. 4 illustrates very schematically another embodiment, in which the hardware accelerator is produced in the form of a coprocessor CPR, communicating with a processor PROC and a memory MEM via a system bus BUS. The processor handles the accelerator as a peripheral, and communicates with it by means of system functions. As the accelerator does not have direct access to the processor's level 1 cache, these system functions use cache consistency protocols, known per se (as a variant, other cache consistency mechanisms known to the person skilled in the art, other than the consistency protocols, may be used). This embodiment is much simpler to implement, but processor/accelerator communication is slower, which reduces the advantage afforded by the acceleration of functions for handling red-black trees.

Whatever the embodiment chosen, a user accesses the functionalities of the hardware accelerator via appropriate function libraries, replacing the standard libraries.

For evaluating the technical result of the invention, a simulator has been created in C++ modeling an ARM Cortex (registered trademark) processor and a hardware accelerator of the type illustrated in FIG. 2. This simulator was used to measure the gains made possible by the use of such a hardware accelerator as part of an implementation of the associative arrays used by dynamic compilation in the LLVM compilation environment. FIG. 5 illustrates, in the form of a histogram, the ratio between the time spent in the handling of associative arrays (implemented by red-black trees) in relation to the total compilation execution time for a plurality of source codes indicated along the horizontal axis. The total execution time for compiling source code designates the execution time of the LLC compiler, in the LLVM environment, spent in compiling a given source code. The various source codes at the input of the LLC compiler, originate from a well-known source code suite, named ‘MiBench’. For each compilation of source code by the compiler LLC, this ratio has been measured for the software implementation of the C++ standard library (bars in light gray), for an optimized software implementation (bars in intermediate gray) and for an implementation using the hardware accelerator according to the invention, in its embodiment incorporated in the processor (bars in dark gray).

It appears that this ratio ranges from 41% for the C++ standard library version to 24% for the software optimized version and to only 12% for the version using the hardware accelerator. In addition, it was possible to highlight a gross gain of approximately a factor of 5 in the management time of associative arrays between the conventional software implementation and that using the hardware accelerator.

1. A hardware accelerator for handling red-black trees, each tree including multiple nodes, each node including data fields of predefined length representing:
a color indicator, taking a binary value;
a key;
an address of another node in the same tree, termed a parent;
an address of another node in the same tree, termed a left child; and
an address of another node in the same tree, termed a right child;
said hardware accelerator including:
at least two registers termed node registers, capable of storing the set of fields of two nodes of a tree; and
logic units configured for receiving from a processor at least one input data item selected from an address of a tree node and a reference key, as well as at least one instruction to be executed; for executing said instruction by performing a combination of the following operations:
sending an address to a memory, receiving from said memory the set of data fields of the node of said tree corresponding to said address and writing them in a register replacing the data fields;
sending to said memory the set of data fields of a node of said tree as well as an address of said memory in which said data fields must be recorded;
changing the value of a color indicator stored in a node register; and
exchanging therebetween two addresses stored in two node registers;
and for supplying said processor with at least one output data item including an address stored in a register node.

2. The hardware accelerator of claim 1, wherein a register, termed a reference register, capable of storing either a reference key, received from said processor, or a reference key and a color indicator.

3. The hardware accelerator of claim 2, wherein said logic units include a processing unit and a control unit (UC), said control unit being configured for:
receiving a node address of a tree as input data and transmitting it to said memory;
receiving a reference key as input data and storing it in said reference register;
receiving an instruction to be executed as input data, and one or more condition signals from said processing unit;
in response to said instruction to be executed and to said condition signal or signals, generating signals for controlling said processing unit; and
supplying, as output data, a node address received from said processing unit.

4. The hardware accelerator in of claim 3, wherein the control unit is a finite state controller.

5. The hardware accelerator of claim 3, wherein a register, termed a temporary register, capable of storing an address, termed a temporary address, of a tree node.

6. The hardware accelerator of claim 5 wherein said processing unit is configured for executing, in response to a control signal, at least the following operations:
a. comparing the reference key stored in said reference register with a key stored in a data field of a node register, and supplying the result of this comparison to said control unit as a condition signal;
b. comparing with a predetermined value an address stored in a data field of a node register, and supplying the result of this comparison to said control unit as a condition signal;
c. comparing with a predetermined value a color indicator stored in a data field of a node register, and supplying the result of this comparison to said control unit as a condition signal;
d. changing the value of a color indicator stored in a data field of a node register;
e. sending to said memory, for writing, the set of data fields of a node register;
f. receiving from said memory the set of data fields of a tree node and storing them in a node register;
g. writing said temporary address, stored in said temporary register, in a data field of a node register, replacing an address stored in said field; and
h. writing an address stored in a data field of a node register in said temporary register, replacing said temporary address.

7. The hardware accelerator of claim 6, wherein said processing unit includes:
a subtraction and selection unit configured for receiving: at a first input, via a first multiplexer, the contents of said temporary register or of said reference register; at a second input, via a second multiplexer, a key or key and color indicator data field from a node register; and at a control input, a control signal from said control unit; and for supplying at its output, according to said control signal, either one of said first and second inputs, or their difference;
a reorganization unit configured for receiving: at a first input, the output of said comparison and subtraction unit; at a second input, a key or key and color indicator data field from a node register, at a third, a fourth and a fifth input, via said second multiplexer, three address data fields from a node register; and at a control input, a control signal from said control unit; and for supplying:
at a first output, a key data, key, key and color indicator or address field present at one of its inputs, the value of said color indicator capable of being modified,
at a second output, an address data field present at its second, its third or its fourth address; and/or
at a third output, the set of data fields representative of a node of said tree, obtained by selection and permutation of the data fields present at its inputs, with optional modification of a color indicator;
a set of comparators to zero of the data fields supplied to the third, fourth and fifth input of said reorganization unit and of a color indicator stored in said reference register, the outputs of said comparators being supplied to said control unit as condition data; and
a data distribution network configured for:
supplying a data field from the first output of the reorganization unit either to said temporary registry, or to said reference register, according to a control signal from said control unit, as well as to said control unit;
supplying a data field from the second output of the reorganization unit to said memory;
supplying data fields from the third output of the reorganization unit to said memory;
supplying data fields from the third output of the reorganization unit or from said memory to one of said node registers, according to a control signal from said control unit.

8. The hardware accelerator of claim 6, wherein said processing unit is configured for generating, in response to an instruction received as input data, a sequence of control signals for executing an operation selected from among the following:
A. Searching, in a red-black tree stored in said memory, for the successor node having a value key immediately greater than that of a node the address whereof is supplied as input data, and supplying, as output data, the address of said successor node;
B. Searching, in a red-black tree stored in said memory, for the predecessor node having a key with a value immediately less than that of a node the address whereof is supplied as input data, and supplying, as output data, the address of said predecessor node;
C. Searching, in a red-black tree stored in said memory and of which the address of an access point is supplied as first input data, for the node the address whereof is supplied as second input data, deleting it and modifying the structure of the red-black tree accordingly;
D. Inserting, in a red-black tree stored in said memory and of which the address of an access point is supplied as first input data, a node the address whereof is supplied as second input data and modifying the structure of the red-black tree accordingly;
E. Searching, in a red-black tree stored in said memory and of which the address of an access point is supplied as first input data, for the first node whose key is greater than or equal to a reference key supplied as second input data and supplying, as output data, the address of this node; and
F. Searching, in a red-black tree stored in said memory and of which the address of an access point is supplied as first input data, for the first node the key whereof is strictly greater than or equal to a reference key supplied as second input data and supplying, as output data, the address of this node.

9. The hardware accelerator of claim 1, wherein said logic units also include an interface device with said memory configured for:
receiving from said control unit the address of a location of said memory; and
transferring the contents of said memory location into a node register, or vice versa.

10. The hardware accelerator of claim 1, including exactly three node registers.

11. The hardware accelerator of claim 1, wherein the color indicator and the key of each node are represented by different bits of the same data field, said color indicator being represented by a single bit of said field.

12. The hardware accelerator of claim 11 wherein each node is represented by:
a data field whereof one bit represents said color indicator and the remaining bits represent said key; and
three other data fields represent the addresses of said parent, left child and right child nodes;
said data fields all having the same number of bits.

13. A processor including a hardware accelerator of claim 1 as a functional unit having access to the first level of cache memory.

14. A computer system including a processor, a memory and a hardware accelerator of claim 1 interconnected by a system bus, said processor being configured or programmed for communicating with said hardware accelerator via system requests and for ensuring cache consistency.
